(19) United States
(12) Patent Application Publication
(10) Pub. No.: US 2006/0126082 A1
(43) Pub. Date: Jun. 15, 2006

(54) Image processing apparatus and method

(76) Inventor: Kwang-Yong Choi, Suwon-si (KR)

Correspondence Address: Robert E. Bushnell, Suite 300, 1522 K Street, N.W., Washington, DC, 20005, US

(21) Appl. No.: 11/284,853

(22) Filed: Nov. 23, 2005

(30) Foreign Application Priority Data
Dec. 14, 2004 (KR) 2004-0105902

(51) Int. Cl. G06K 15/02

(52) U.S. Cl. 358/1.2

(57) ABSTRACT

An image processing apparatus and method are adapted to form an image of an object photographed by a camera at a preset resolution; crop a preset portion from the image; and display the cropped image portion in response to a request from a user. Then, the specific image portion can be zoomed or magnified without degradation of image quality and the zooming power or magnification can be adjusted by cropping and size-adjustment of the specific image portion.

### CLAIM OF PRIORITY

This application makes reference to, incorporates the same herein, and claims all benefits accruing under 35 U.S.C. § 119 from an application for APPARATUS AND METHOD FOR PROCESSING IMAGE earlier filed in the Korean Intellectual Property Office on 14 Dec. 2004 and there duly assigned Serial No. 2004-0105902.

### BACKGROUND OF THE INVENTION

1. Field of the Invention

The present invention relates to image processing, and more particularly, to an image processing apparatus and method which are adapted to crop a specific portion from an image taken by a camera at a preset image size and to adjust the cropped image size.

2. Description of the Related Art

The recent rapid development of the information society demands the development of a terminal having various functions.

Therefore, mobile terminals (for example, a mobile phone and an MP3 player) have been developed to have various functions, such as image/voice transceiving and music/dynamic image replay to comply with the multimedia age. Mobile terminals are being equipped with a camera function in order to further conform to the multimedia age. For example, when needed at a task, a user can take a photograph of an object with a mobile terminal having a camera function and transmit the image of the object to a company via the mobile terminal. The user can also edit the image of the object to upload the image onto a home page.

An image processing apparatus including a mobile terminal having a camera function and includes a lens unit, an image sensor, a memory, an image-processing unit having a resolution converter and a magnifier/reducer, and a display unit.

The lens unit forms an image of an object and provides the image to the image sensor. The lens unit can have a zoom function to magnify the image of an object to a predetermined magnification and to provide the magnified image to the image sensor.

The image sensor photoelectrically converts an image formed by the lens unit and provides the converted image to the image-processing unit.

In the image-processing unit, the resolution converter converts the resolution of an image provided by the image sensor into a preset resolution, and the magnifier/reducer magnifies or reduces an image provided by the image sensor or the resolution converter to a predetermined magnification. The image-processing unit stores an image from the image sensor, the resolution converter and the magnifier/reducer in the memory or displays the same via the display unit according to user selection.

The above terminology ‘resolution’ is used to indicate the definition of an image displayed on a display unit having a specific display area (width x length), which can be expressed by the number of pixels existing in the display area of the display unit. Hereinafter, this terminology ‘resolution’ will have the same meaning unless otherwise mentioned. That is, the resolution of the display unit is determined according to the number of pixels on a display unit, and the display unit can express an image more clearly when it has more pixels.

In addition, an image from the image sensor has a size (width x length) preferably corresponding to the size of the display unit that displays the image.

The memory 120 stores images provided from the image sensor, the resolution converter and the magnifier/reducer.

The display unit displays images provided from the image sensor, the resolution converter and the magnifier/reducer.

When a user photographs an object, its image is formed by the lens unit, photoelectrically converted by the image sensor, and provided to the image-processing unit.

In response to a request, the image-processing unit controls the resolution converter to convert the resolution of the image from the image sensor into a preset resolution. Then, the resolution converter converts the resolution of the image from the image sensor into the preset resolution. The resolution of the image from the image sensor is generally the maximum resolution supported by the image processing apparatus.

For example, where a resolution provided by the image sensor is 1600×1200 (maximum resolution) and a preset resolution is 800×600, an established resolution adjustment algorithm converts the maximum resolution 1600×1200 to the preset resolution 800×600.

The resolution 1600×1200 indicates that an image is displayed with 1600×1200 pixels on the display unit, and the resolution 800×600 indicates that an image is displayed with 800×600 pixels on the display unit. The maximum resolution is lowered owing to the limited data storage capacity of the memory.

Then, the image-processing unit changes the resolution of the image from the image sensor before displaying the image via the display unit.

Upon a request from a user, the image-processing unit magnifies or zooms a specific image portion of the image displayed on the display unit at a preset magnification, and displays the magnified image via the display unit.

In addition, the image-processing unit controls the memory to store the image expressed at the changed resolution and the image magnified at the preset magnification in response to a request from the user.

When a user makes a digital zoom request to zoom or magnify a specific portion of the image, the resolution of which is lowered from the maximum resolution, the specific image portion is magnified at a preset magnification set by the user. However, a clean image cannot be formed since the resolution of the image is lowered from the maximum resolution, and the specific portion of the image is damaged when magnified at the preset magnification.

### SUMMARY OF THE INVENTION

It is therefore an object of the present invention to provide an image processing method and apparatus which are adapted to select a specific portion from an image at the maximum resolution and to adjust the size of the selected specific image portion at a preset image size.

According to an aspect of the present invention for realizing the above object, an image processing apparatus is provided, the apparatus comprising: a terminal having a camera: and a processing unit adapted to form an image of an object photographed by the camera at a preset resolution; crop a preset portion from the image; and display the cropped image portion in response to a request from a user.

The terminal preferably comprises at least one of the group consisting of an MP3 player, a Personal Digital Assistant (PDA) and a mobile phone.

The preset resolution preferably comprises the maximum resolution of the camera.

The processing unit preferably comprises a size-adjustment unit adapted to adjust the size of the cropped image portion to a preset image size in response to a request by the user.

The size of the cropped image portion is preferably larger than the preset image size.

According to another aspect of the present invention for realizing the above object, an image processing apparatus is provided, the apparatus comprising: a terminal having a camera; a cropper adapted to form an image of an object photographed by the camera at a preset maximum resolution and to crop a preset portion of the image; and a size-adjustment unit adapted to adjust the size of the cropped image portion to a preset image size in response to a request by the user.

The size of the cropped image portion is preferably larger than the preset image size.

According to still another aspect of the present invention for realizing the above object, an image processing method is provided, the method comprising; providing a terminal having a camera; forming an image of an object photographed by the camera at a preset resolution; cropping a specific portion of the image in response to a request by a user to crop the specific portion of the image; and displaying the cropped image portion in response to a request by the user.

Providing the terminal preferably comprises providing at least one of the group consisting of an MP3 player, a Personal Digital Assistant (PDA) and a mobile phone.

The preset resolution is preferably the maximum resolution of the camera.

The image processing method preferably further comprises: determining whether or not there is a request by the user to adjust the size of the cropped image portion to the size of a preset image; and adjusting the size of the cropped image portion to the size of the preset image in response to a request by the user.

The size of the image portion is preferably larger than the preset image size.

According to yet another aspect of the present invention for realizing the above object, an image processing method is provided, the method comprising; providing a terminal having a camera; forming an image of an object photographed by the camera at a preset maximum resolution; cropping a specific portion of the image in response to a request by a user to crop the specific portion of the image; and adjusting the size of the cropped image portion to the size of the preset image in response to a request by the user.

The size of the cropped image portion is preferably larger than the preset image size.

### BRIEF DESCRIPTION OF THE DRAWINGS

A more complete appreciation of the present invention, and many of the attendant advantage thereof, will become readily apparent as the present invention becomes better understood by reference to the following detailed description when considered in conjunction with the accompanying drawings in which like reference symbols indicate the same or similar components, wherein:

FIG. 1 is a block diagram of an image processing apparatus;

FIG. 2 is a block diagram of an embodiment of an image processing apparatus according to the present invention;

FIG. 3 is a flowchart of an embodiment of an image processing method according to the present invention; and

FIGS. 4A and 4B are views of a change of image size according to an embodiment of the present invention.

### DETAILED DESCRIPTION OF THE INVENTION

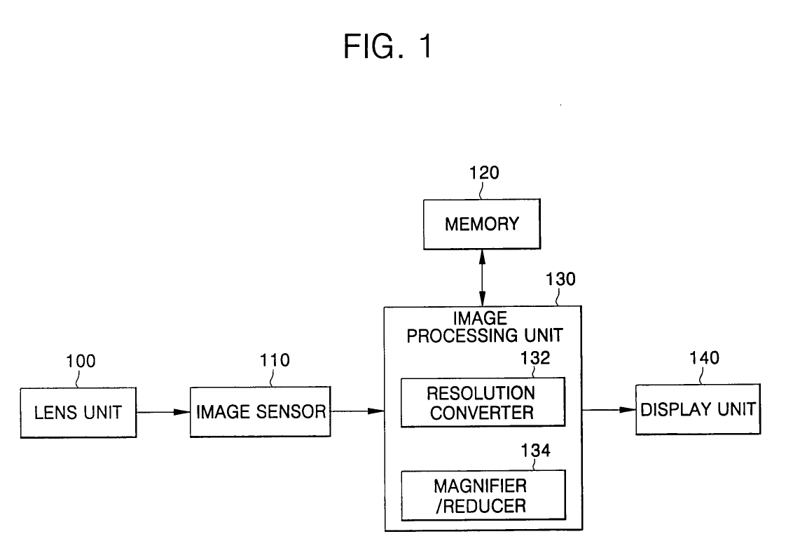

An image processing apparatus including a mobile terminal having a camera function is depicted in FIG. 1 which is a block diagram of an image processing apparatus.

As shown in FIG. 1, the image processing apparatus includes a lens unit 100, an image sensor 110, a memory 120, an image-processing unit 130 having a resolution converter 132 and a magnifier/reducer 134, and a display unit 140.

The lens unit 100 forms an image of an object and provides the image to the image sensor 110. The lens unit 100 may have a zoom function to magnify the image of an object to a predetermined magnification and to provide the magnified image to the image sensor 110.

The image sensor 110 photoelectrically converts an image formed by the lens unit 100 and provides the converted image to the image-processing unit 130.

In the image-processing unit 130, the resolution converter 132 converts the resolution of an image provided by the image sensor 110 into a preset resolution, and the magnifier/reducer 134 magnifies or reduces an image provided by the image sensor 110 or the resolution converter 132 to a predetermined magnification. The image-processing unit 130 stores an image from the image sensor 100, the resolution converter 132 and the magnifier/reducer 134 into the memory 120 or displays the same via the display unit 140 according to user selection.

The above terminology ‘resolution’ is used to indicate the definition of an image displayed on a display unit having a specific display area (width×length), which can be expressed by the number of pixels existing in the display area of the display unit. Hereinafter, this terminology ‘resolution’ will have the same meaning unless otherwise mentioned. That is, the resolution of the display unit is determined according to the number of pixels on a display unit, and the display unit can express an image more clearly when it has more pixels.

In addition, an image from the image sensor 110 has a size (width×length) preferably corresponding to the size of the display unit 140 that displays the image.

The memory 120 stores images provided from the image sensor 110, the resolution converter 132 and the magnifier/reducer 134.

The display unit 140 displays images provided from the image sensor 110, the resolution converter 132 and the magnifier/reducer 134.

When a user photographs an object, its image is formed by the lens unit 100, photoelectrically converted by the image sensor 110, and provided to the image-processing unit 130.

In response to a request, the image-processing unit 130 controls the resolution converter 132 to convert the resolution of the image from the image sensor 110 into a preset resolution. Then, the resolution converter 132 converts the resolution of the image from the image sensor 110 into the preset resolution. The resolution of the image from the image sensor 110 is generally the maximum resolution supported by the image processing apparatus.

For example, where a resolution provided by the image sensor 110 is 160×1200 (maximum resolution) and a preset resolution is 800×600, an established resolution adjustment algorithm converts the maximum resolution 1600×1200 to the preset resolution 800×600.

The resolution 1600×1200 indicates that an image is displayed with 1600×1200 pixels on the display unit, and the resolution 800×600 indicates that an image is displayed with 800×600 pixels on the display unit. The maximum resolution is lowered owing to the limited data storage capacity of the memory.

Then, the image-processing unit 130 changes the resolution of the image from the image sensor 110 before displaying the image via the display unit 140.

Upon a request from a user, the image-processing unit 130 magnifies or zooms a specific image portion of the image displayed on the display unit 140 at a preset magnification, and displays the magnified image via the display unit 140.

In addition, the image-processing unit 130 controls the memory 120 to store the image expressed at the changed resolution and the image magnified at the preset magnification in response to a request from the user.

Hereinafter, an image processing apparatus and method in accordance with an embodiment of the present invention is described in detail with reference to the accompanying drawings.

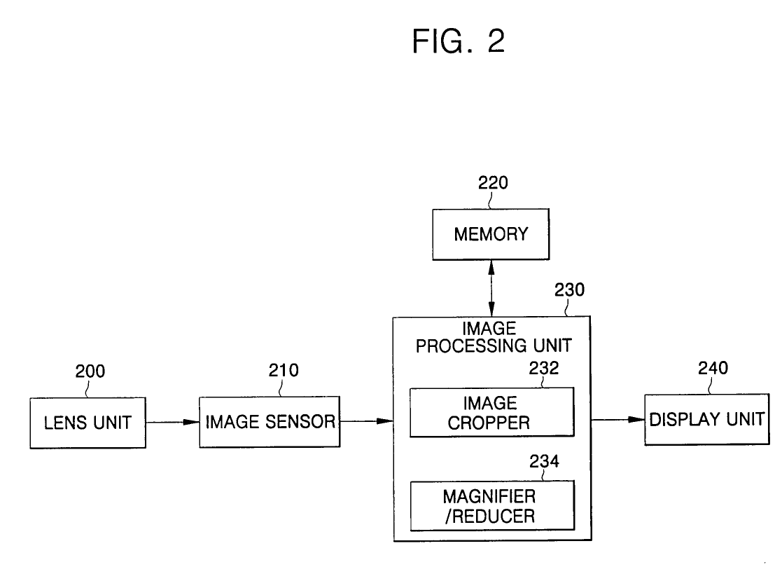

FIG. 2 is a block diagram of an image processing apparatus in a terminal according to an embodiment of the present invention.

As shown in FIG. 2, the image processing apparatus of the invention includes a lens unit 200, an image sensor 210, a memory 220, an image-processing unit 230 having an image cropper 232 and a magnifier/reducer 234 and a display unit 240. The terminal can be a mobile phone or an MP3 player.

The lens unit 200 forms an image of an object and provides the image to the image sensor 210. In addition, the lens unit 200 may have an optical zoom function to magnify an image of an object at a preset magnification and to provide the magnified image to the image sensor 110.

The image sensor 210 photoelectrically converts an image of an object formed by the lens unit 200 and provides the converted image to the image-processing unit 230.

In the image processing unit 230, the image cropper 232 crops an image from the image sensor 110 when a specific portion of the image is selected by a user, and the magnifier/reducer 234 magnifies or reduces the cropped image to a preset size. The image processing unit 230 stores images from the image sensor 100, the image cropper 232 and the magnifier/reducer 234 in the memory 220, or displays these images on the display unit 240.

In addition, an image from the image sensor 210 has a size (width×length) preferably corresponding to that of the display unit 240 for displaying the image.

The memory 220 stores images from the image sensor 210, the cropper 232 and the magnifier/reducer 234.

The display unit 240 displays images from the image sensor 210, the cropper 232 and the magnifier/reducer 234.

When an object is photographed by a user, its image is formed by the lens unit 200, photoelectrically converted by the image sensor 210, and provided to the image processor 230. The image processor 230 displays the image from the image sensor 210 on the display unit 240.

In response to a cropping request from the user, the image-processing unit 230 controls the cropper 232 to crop a specific portion of the image from the image sensor 210. The size of the image from the image sensor 210 and the size of the specific image portion that is to be cropped can be expressed by the number of pixels for indicating the resolution of images. The size of the image from the image sensor is preferably larger than that of the specific portion of the image that is to be cropped.

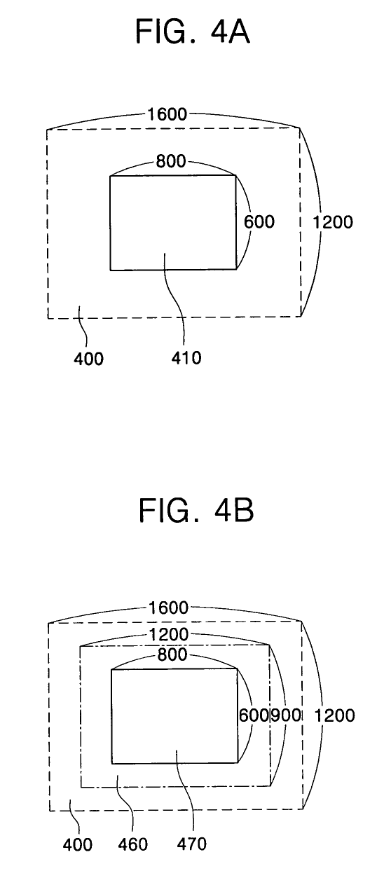

This concept is illustrated in FIG. 4A.

As shown in FIG.4A, an image 400 from the image sensor 210 has a size of ‘1600×1200’ resolution (i.e., the maximum resolution), and a specific image portion 410 that is to be cropped has a size of ‘800×600’ resolution. This causes the size of the specific image portion 410 that is to be cropped to be zoomed or magnified four times with respect to the size in the image 400 from the image sensor 210. This also requires that each pixel size for expressing the size of the image 400 be equal to each pixel for expressing the specific image portion 410. It is also to be understood that the specific image portion that is to be cropped by the user is not limited to those portions shown in FIG. 4A.

In response to a request to adjust an image size for a cropped specific portion at a preset image size, the image processing unit 230 controls the magnifier/reducer 234 to magnify or reduce the image size for the cropped specific portion in order to adjust the image to the preset image size. This will be described further with reference to FIG. 4B.

As shown in FIG. 4B, the size of an image 460 for the cropped specific portion is adjusted to the size of a preset image 470. This zooms or magnifies the size of the preset image 470 four times compared to the size in an image 400 from the image sensor 210. Furthermore, the size of the image 460 for the cropped specific portion intermediates between the size of the image 400 from the image sensor 210 and the size of the preset image 470, such that the size of the image 460 for the cropped specific portion is adjusted to the size of the preset image 470 results in magnification or zooming up to four times. That is, an image of a size corresponding to a resolution equal to or less than a maximum resolution is cropped from an image of the maximum resolution, thereby resulting in image magnification without degradation in image quality. Furthermore, magnification or zooming power can be adjusted through cropping and size adjustment.

The size of the image from the image sensor 210, the size of the image 460 for the cropped specific portion and the size of the preset image 470 can be expressed by the resolution, which can be expressed by the number of pixels. Preferably, the size of the image 460 for the cropped specific portion is larger than that of the preset image 470.

Then, in response to a request from the user, the image-processing unit 230 stores the cropped image or the sized-adjusted image of the cropped image in the memory 220.

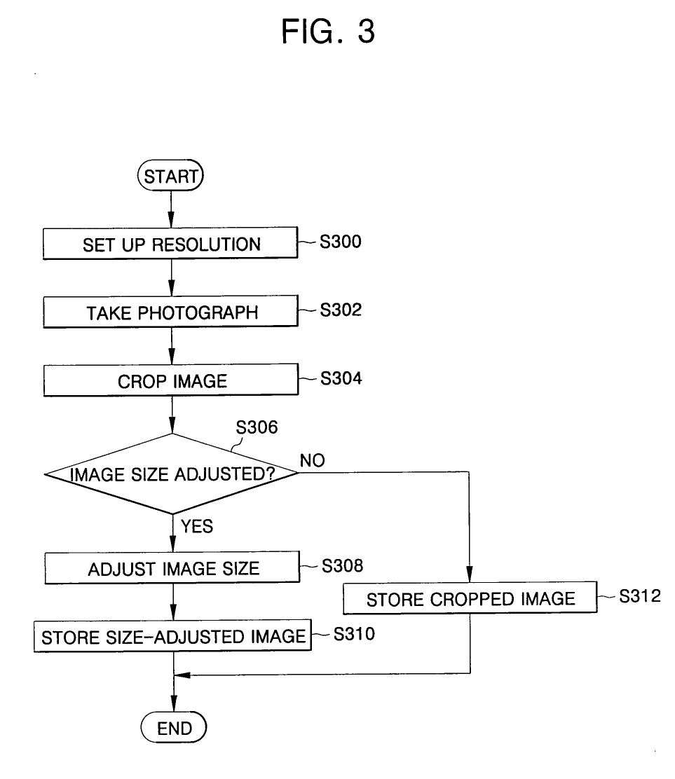

FIG. 3 is a flowchart of an embodiment of an image processing method according to the present invention.

As shown in FIG. 3, a user sets a resolution considering the memory capacity of the image processing apparatus in S300, and an object is photographed. The image of the photographed object is formed by a lens and then provided to an image sensor. The image of the object is photoelectrically converted by the image sensor and displayed by a display unit to the user in S302. The image displayed by the display unit has a resolution provided by the image sensor. Generally, the resolution provided by the image sensor is the maximum resolution that can be supported by the image processing apparatus.

Then, in response to a request from the user, a specific portion is cropped from the image displayed by the display unit, and an image for the cropped specific portion is displayed by the display unit in S304.

A determination is made as to whether or not there is a request from the user to adjust the image size for the cropped specific portion to an image size corresponding to a preset resolution in S306. The image size can be expressed by the resolution, which is expressed by the number of pixels.

If there is a request from the user to adjust the image size, the image size for the cropped specific portion is compared with the image size corresponding to a preset resolution, and if the image size for the cropped specific portion is equal to the image size corresponding to a preset resolution, the image size for the cropped specific portion is adjusted to the image size corresponding to a preset resolution in S308. The image size for the cropped specific portion is preferably larger than the image size corresponding to a preset resolution. In addition, each pixel for expressing the image size for the cropped specific portion is required to have the same size as that for expressing the image size corresponding to a preset resolution.

In S310, a determination is made as to whether or not there is a request by the user to store the size-adjusted image, and if there is a request by the user to store the size-adjusted image, the size-adjusted image is stored in a memory in S310.

On the contrary, if there is no request by the user to adjust the image size, a determination is made as to whether or not there is a request by the user to store the image for the cropped specific portion, and if there is a request to store the image for the cropped specific portion, the image for the specific portion is stored into the memory S312.

While this invention has been described in conjunction with exemplary embodiments in the specification, it is apparent to those skilled in the art that various modifications and variations can be made without departing from the scope of the present invention, which is defined by the appended claims.

As described hereinbefore, the image processing apparatus and method of the present invention can crop a specific portion from an image having the maximum resolution and adjust the image size for the cropped specific portion to a preset image size, so as to thereby zoom or magnify the specific image portion without degradation of image quality as well as to adjust the zooming power or magnification through cropping and size-adjustment of the specific image portion.

What is claimed is:

1. An image processing apparatus comprising:
a terminal having a camera; and
a processing unit adapted to form an image of an object photographed by the camera at a preset resolution; crop a preset portion from the image; and display the cropped image portion in response to a request from a user.

2. The image processing apparatus according to claim 1, wherein the terminal comprises at least one of the group consisting of an MP3 player, a Personal Digital Assistant (PDA) and a mobile phone.

3. The image processing apparatus according to claim 1, wherein the preset resolution comprises the maximum resolution of the camera.

4. The image processing apparatus according to claim 1, wherein the processing unit comprises a size-adjustment unit adapted to adjust the size of the cropped image portion to a preset image size in response to a request by the user.

5. The image processing apparatus according to claim 4, wherein the size of the cropped image portion is larger than the preset image size.

6. An image processing apparatus comprising:
a terminal having a camera;
a cropper adapted to form an image of an object photographed by the camera at a preset maximum resolution and to crop a preset portion of the image; and
a size-adjustment unit adapted to adjust the size of the cropped image portion to a preset image size in response to a request by the user.

7. The image processing apparatus according to claim 6, wherein the size of the cropped image portion is larger than the preset image size.

8. An image processing method comprising;
providing a terminal having a camera;
forming an image of an object photographed by the camera at a preset resolution;
cropping a specific portion of the image in response to a request by a user to crop the specific portion of the image; and
displaying the cropped image portion in response to a request by the user.

9. The image processing method according to claim 8, wherein providing the terminal comprises providing at least one of the group consisting of an MP3 player, a Personal Digital Assistant (PDA) and a mobile phone.

10. The image processing method according to claim 8, wherein the preset resolution is the maximum resolution of the camera.

11. The image processing method according to claim 8, further comprising:
determining whether or not there is a request by the user to adjust the size of the cropped image portion to the size of a preset image; and
adjusting the size of the cropped image portion to the size of the preset image in response to a request by the user.

12. The image processing method according to claim 11, wherein the size of the image portion is larger than the preset image size.

13. An image processing method comprising:
providing a terminal having a camera;
forming an image of an object photographed by the camera at a preset maximum resolution;
cropping a specific portion of the image in response to a request by a user to crop the specific portion of the image; and
adjusting the size of the cropped image portion to the size of the preset image in response to a request by the user.

14. The image processing method according to claim 13, wherein the size of the cropped image portion is larger than the preset image size.
